(19) United States
(12) Patent Application Publication
(10) Pub. No.: US 2016/0324116 A1
(43) Pub. Date: Nov. 10, 2016

(54) Pet Toy And Shelter

(71) Applicant: Kim S. Ballentyne, Parike (BE)

(72) Inventor: Kim S. Ballentyne, Parike (BE)

(21) Appl. No.: 15/192,641

(22) Filed: Jun. 24, 2016

Related U.S. Application Data
(63) Continuation-in-part of application No. 14/015,327, filed on Aug. 30, 2013.
(60) Provisional application No. 61/812,108, filed on Apr. 15, 2013.

(51) Int. Cl. A01K 1/035; A01K 15/02

(52) U.S. Cl. CPC A01K 1/035; A01K 15/025

(57) ABSTRACT

A pet toy and shelter is disclosed. An example pet toy and shelter may include a collapsible housing having a support structure, and at least one passage formed therein for entry and exit of a pet. The pet toy and shelter may also include a fringe curtain to at least partially cover the passage in the collapsible housing, the fringe curtain having a plurality of strips. The collapsible housing is configured to be oriented both upright and upside down so that the fringe curtain provides cover, a hiding place, a curtain from which to look out or through, shelter for the pet to relax and sleep in, and entertainment for the pet.

### PRIORITY CLAIM

This application is a continuation-in-part (CIP) of U.S. patent application Ser. No. 14/015,327 filed Aug. 30, 2013 titled “Pet Toy And Shelter” of Kim S. Ballentyne, which claims the priority benefit of U.S. Provisional Patent Application No. 61/812,108 filed Apr. 15, 2013 titled “Pet Toy And Shelter” of Kim S. Ballentyne, each hereby incorporated by reference in its entirety as though fully set forth herein.

### BACKGROUND

People have kept animals as pets to provide labor, companionship and entertainment. Persons with pets typically provide stimulation to these pets by training or playing with them. To enrich training and play, pet owners frequently make use of toys and other accessories. Well known accessories include balls and noise makers. Some pet owners also enjoy providing their pets with wearable accessories such as shirts, boots or backpacks.

### BRIEF DESCRIPTION OF THE DRAWINGS

FIG. 1 illustrates a perspective view of an example pet toy and shelter.

FIG. 2 illustrates a perspective view of the example pet toy and shelter in a folded or collapsed configuration.

FIG. 3 illustrates assembly of the example pet toy and shelter.

FIGS. 4-6 illustrates a front-side plan view of the example pet toy and shelter.

FIG. 6 illustrates a rear perspective view of the example pet toy and shelter.

FIG. 7 illustrates a back-side plan view of the example pet toy and shelter

FIG. 8 illustrates a side plan view of the example pet toy and shelter.

FIG. 9 illustrates a top plan view of the example pet toy and shelter.

FIG. 10 illustrates an example pet toy and shelter as it may be provided as a kit.

FIG. 11 illustrates example assembly instructions for the example pet toy and shelter.

FIG. 12 illustrates another example pet toy and shelter with a fringe and decorative frame.

FIG. 13 illustrates an example pet toy and shelter with a variety of additional fringe sheets.

FIG. 14 illustrates a perspective view of another example pet toy and shelter.

FIGS. 15-16 illustrate perspective views of e example pet toy and shelter.

FIGS. 17-18 illustrate views of a pet playing with the example pet toy and shelter.

FIG. 19 is a front view showing an example pet toy and shelter,

FIGS. 20A-24 illustrate various configurations of the fringe curtain of the pet toy and shelter.

FIG. 25 is a high-level block diagram of a control system for the pet toy and shelter.

### DETAILED DESCRIPTION

A pet toy and shelter is disclosed herein as it may be provided for household pets, such as but not limited to cats. The example pet toy and shelter may be used by anybody who passionately cares about his or her pet. The example pet toy and shelter is safe, easy to assemble, provides endless hours of fun for pets and their owners, and can be used as a sleeping area. It may also serve as a temporary and/or disposable and removable housing. It may be easily displayed in the store (e.g., at the checkout or point of sale zones) alone or with existing pet toys and accessories. The example pet toy and shelter has the ability to assume a collapsed state, making it easily transported and stacked for storage.

An example pet toy end shelter may include a collapsible housing having a support structure having a single and/or multiple layers, and at least one passage formed therein for entry and exit of a pet. The pet toy and shelter may also include a fringe curtain to at least partially cover the passage in the collapsible housing, the fringe curtain having a plurality of strips. The collapsible housing is configured to be oriented both upright and upside down so that the fringe curtain provides cover, a hiding place, a curtain from which to look out or through, shelter for the pet to relax and, sleep in, and entertainment for the pet.

The example pet toy and shelter is described herein primarily with reference to its use with cats or more generally, feline pets), although other animals or pets may also benefit from its use. In an example, the pet toy and shelter is eco-friendly, and may be prefabricated from recycled cardboard or other recycled material. Also in an example, the pet toy and shelter requires no batteries or electricity to use.

Before continuing, it is noted that as used herein, the terms “includes” and “including” mean, but is not limited to, “includes” or “including” and “includes at least” or “including at least.” The term “based on” means “based on” and “based at least in part on.”

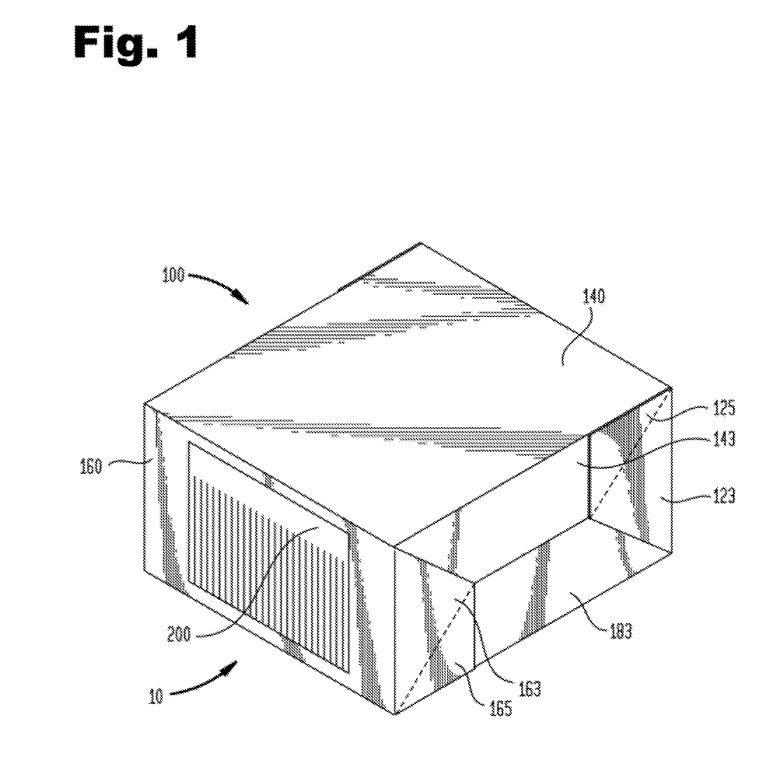

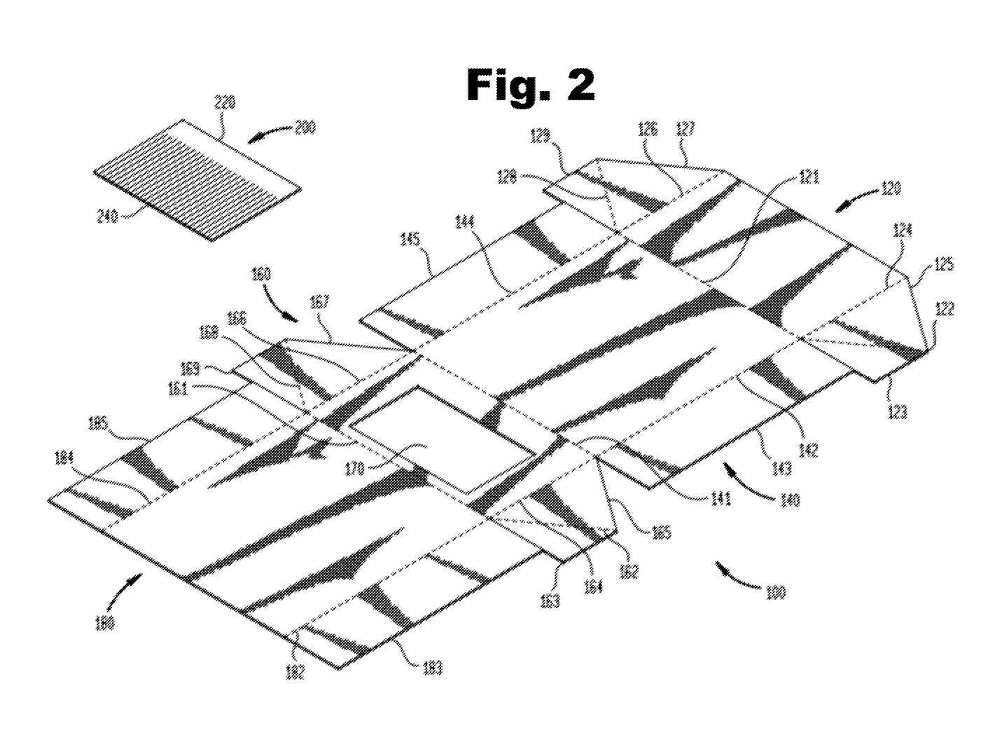

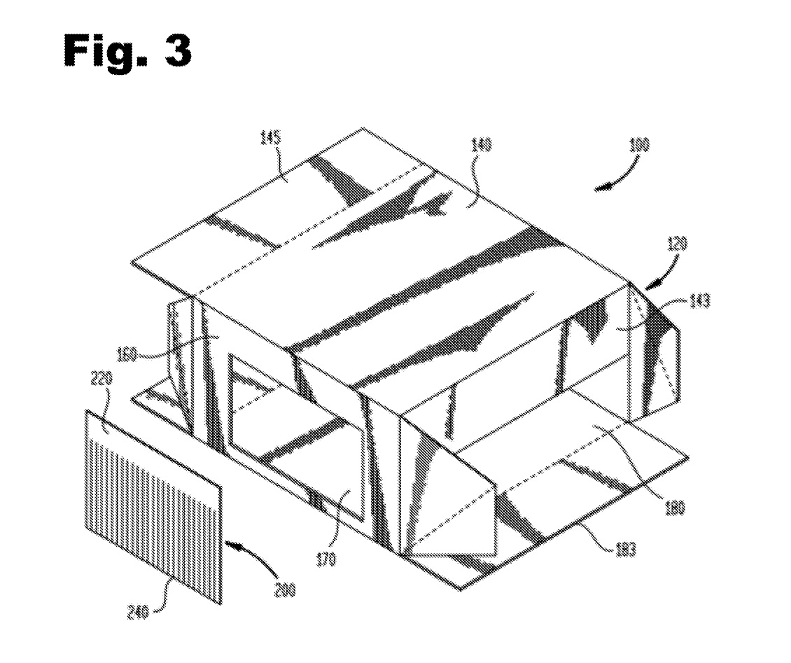

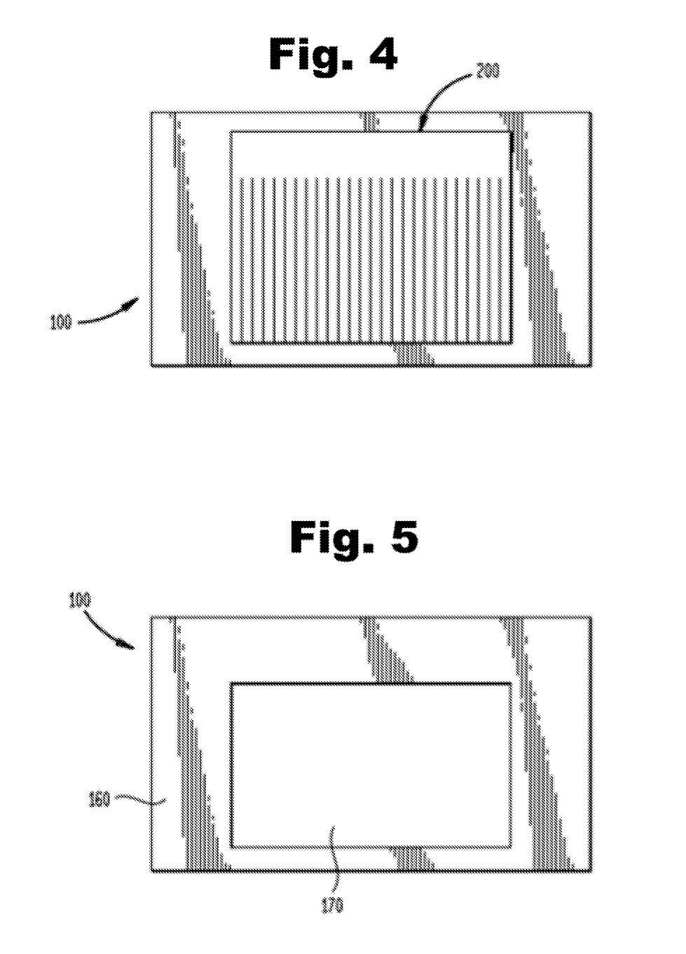

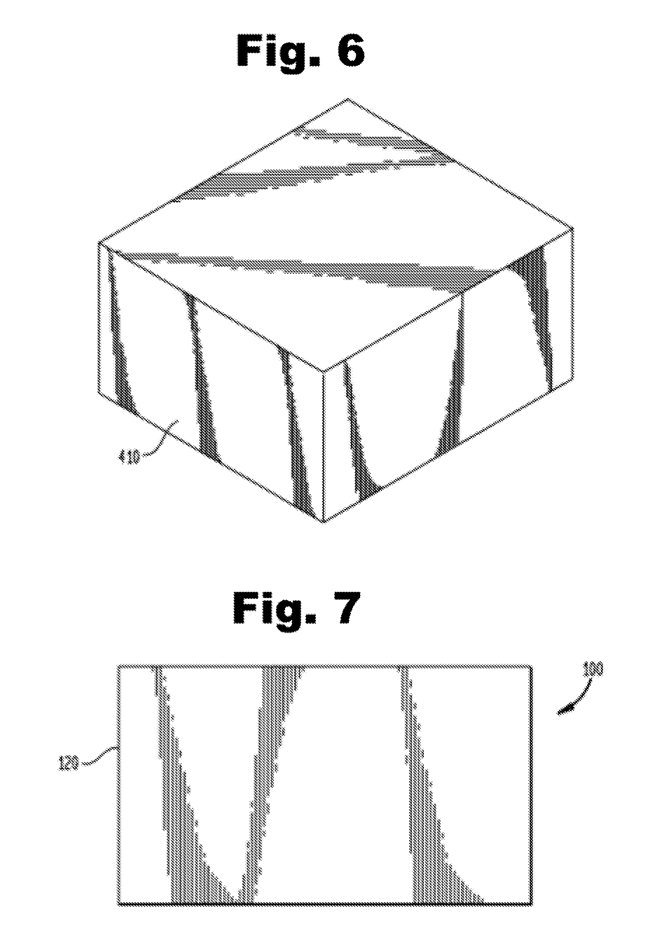

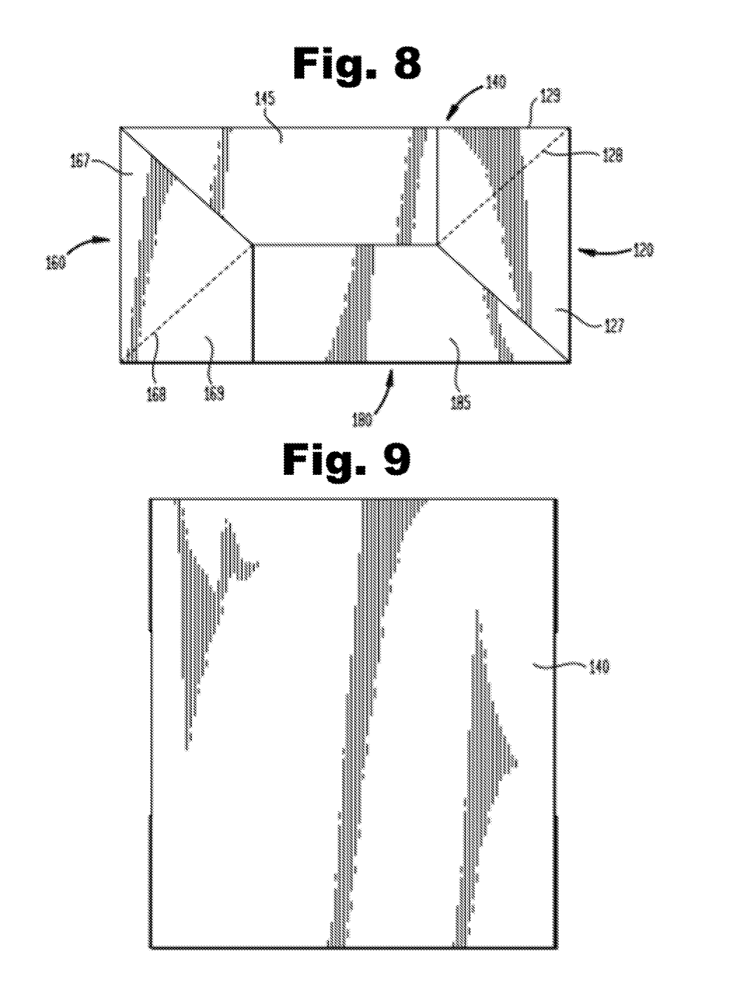

FIG. 1 is a perspective view of an example pet toy and shelter 10. FIG. 2 illustrates a perspective view the example pet toy and shelter 10 in a collapsed state. FIG. 3 illustrates a perspective view of the example pet toy and shelter 10 in a partially assembled state. FIG. 4 is a front-side plan view of the example pet toy and shelter 10 having a fringe. FIG. 5 is a front-side plan view of the example pet toy and shelter 10 with the fringe removed to reveal an entryway sized for a cat or other pet to fit through. FIG. 6 illustrates a rear view of the example pet toy and shelter after assembly and wrapping to provide a decorative motif. FIG. 7 illustrates a back-side plan view of the example pet toy and shelter, FIG. 8 illustrates a side plan view of an example pet toy and shelter. FIG. 9 illustrates a top plan view of the example pet toy and shelter.

In an example, the pet toy and shelter 10 includes a housing 100 which may be assembled by expanding or erecting a box from a collapsed state (see, e.g. FIGS. 2-3) to the assembled configuration shown in FIG. 1. The example pet toy and shelter 10 may be returned to the collapsed state, if desired, for example for storage or transport.

In the unassembled or collapsed state, the housing 100 may assume a generally or substantially flat profile, thereby occupying a relatively small space. The example pet toy and shelter may assume a prismatoid shape in the erect state, such as, for example, a rectangular prism, a pentagonal prism or a pyramid. Other shapes are also contemplated as being within the scope of the disclosure herein.

A number of facets 120, 140, 160 and 180 may be configured for relative flexion along creases or flexible fold-lines 121, 141 and 161 between respective adjacent facets 120 and 140, 140 and 160, and 160 and 180. Example facets 120, 140, 160 and 180 may include pivoting flaps 125, 127, 143, 145, 165, 167, 183 and 185, Creases or flexible fold lines 124, 126, 142, 144, 164, 166, 168, 182 and 184 facilitate flexion of flaps relative to respective facets 120, 140, 160 and 180. Some of the flaps, such as 125, 127, 165 and 167 may be further provided with sub-flaps 123, 129, 163 and 169 which are enabled for flexion relative to the respective flap 125, 127, 165 or 167 by creases or fold-lines 122, 128, 162 and 168. Two or more of the flaps 125, 127, 143, 145, 165, 167, 183 and 185 and sub-flaps 123, 129, 163 and 169 may overlap to stabilize toy and shelter 10 in the erect state, Still other facets may be included based at least in part on design considerations.

A passage or entryway 170 (e.g., an opening or hole) is formed through one or more of the facets 120, 140, 160 and 180, for example facet 160, and may take any of a variety of shapes including but not limited to rectangular, square, octagonal, circular, semi-circular or triangular. Other shapes are also contemplated. Passage 170 may be any hole, opening, hollow space, or receptacle used to provide a hollow object such as a cavity, aperture den, burrow, or gap.

In an example, passage 170 may be pre-out into housing 100. In another example, perforations may be provided in the housing 100 for the end-user to form a selectable, but at least semi-custom size passage 170 in the housing 100. A smaller passage may thereby be created, by the user for smaller pets, and a larger passage may be created by the user for larger pets. In yet other examples, housing 100 may be manufactured with demarcations indicating lines which the user may cut to provide passage 170. As with perforations, demarcations may be provided such that one of a variety of passage sizes may be selected by the end user. In an example, the user may change the size of the opening as the pet grows.

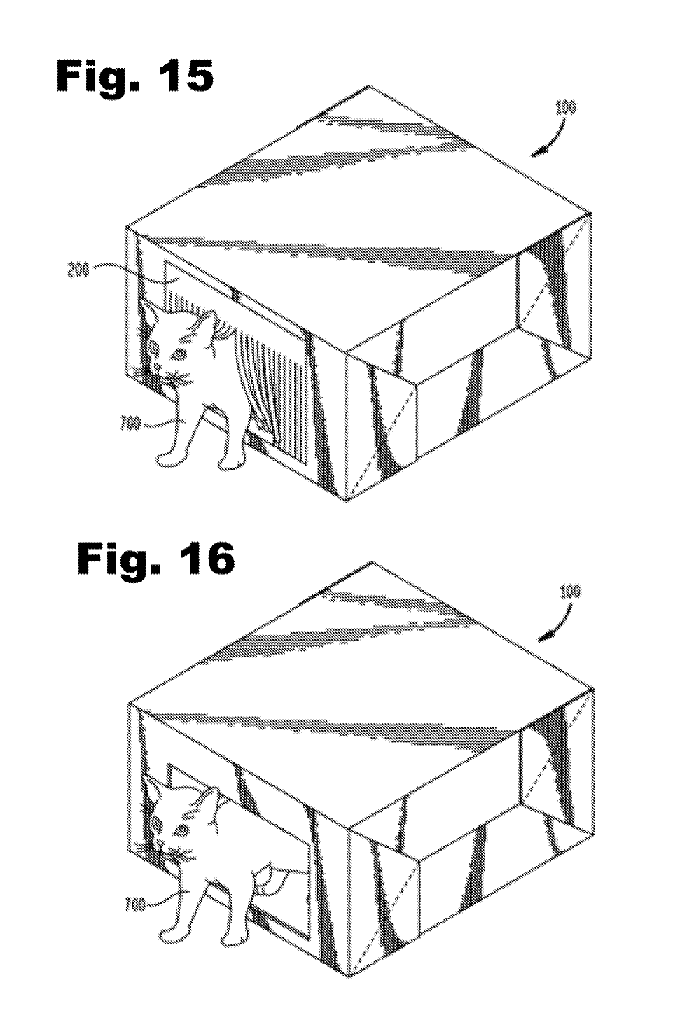

FIG. 14 illustrates a housing 600 having facets 620, 640, 660 and 680 wherein facet 660 includes perforations 670 for forming a passage. Housing 100 may be formed of any of a variety of materials including foldable materials such as cardboard, recycled material, plastic or composites.

While example housing 100 is illustrated as being disconnected in a collapsed state, it is noted that housing 100 may also have a continuous or closed loop configuration in the collapsed state. For example, in addition to a first edge of front facet 160 being joined with a first edge of bottom facet 180, a second edge of front facet 160 may be joined with a first edge of top facet 140 and a second edge of top facet 140 may be joined with a first edge back facet 120. A second edge of back facet 120 may also be, joined with a second edge of top facet 180.

In an example, a fringe 200 is attachable to housing 100 in any of a variety of locations, for example, adjacent to and at least partially covering passage 170. Fringe 200 may include a base portion 220 and a plurality of individual flexible fibers or strips 240 extending from the base portion 220. When fringe 200 is coupled with housing 100 such that passage 170 is at least partially covered, a pet is able to pass through the fringe 200 when entering or exiting passage 170.

In an example, the fringe 200 may include a coupling for detachably securing the fringe 200 to the housing 100 (e.g., to the outside and/or inside) of the passage. Any of a variety of couplings may be used including but not limited to pins, hook-and-loop fasteners, magnets, or adhesives. Adhesives may be pre-provisioned to the fringe 200, as by a material which becomes tacky by removing a film strip or upon application of moisture (such as with envelopes or postage stamps). In an example, the fringe 200 may be permanently affixed to housing 100 by a permanent adhesive, either by a manufacturer, supplier, by an end-user, or provided as an integral portion of the toy and shelter 10.

It should be noted that the fringes 200 can be incorporated in any other pet toys, furniture, accessories, etc. For example, the fringes may also be used with a climbing den, climbing pole, cat frame, cat tree, any form of cat toys using boxes or enclosures surrounded by a housing. In an example, the fringe 200 is attachable to an entry way, entrance or exit to any device, such as but not limited to, a housed or hooded box or an enclosed housing box.

The fringe 200 provides an unproblematic, safe, comfortable, simple, effective, easy to quietly maneuver, pet-friendly entrance, entryway and exit for a pet to conveniently and privately access the housed box which automatically ensures privacy and allows sufficient air ventilation for pets to maintain their privacy and secrecy. Indeed, more than one entryway may be provided, and fringe 200 may be provided on one or more of these passageways.

The fringe 200 helps ensure that pets feel less vulnerable when they are sleeping because the pet can still have a view and see what is happening around them and be provided with a sense of comfort, security, and privacy.

Cats are almost neurotic about their need to feel safe and secure. Hooded or housed boxes incorporating the fringe 200 may provide cats with a quiet protected place. Young kittens and old geriatric cats with physical limitations may have difficulties using certain types of hooded boxes. A solid, swing or fixed permanent door or flap may prevent access or trap your pet inside the box housing or hooded box. The fringe 200 enables easy access for the pet and can be readily disposed of, replaced, and recycled to prevent diseaases. For hygienic and sanitation purposes, the fringe 200 can be readily disposed of, replaced and recycled and prevent diseases.

Pets like to keep themselves clean and are conscious about their surroundings, and a place of refuse which is well concealed, provides shelter, and includes multiple non-restrictive escape routes between the hidden spaces and gaps which allows them to observe unnoticed and remain alert and ready to pounce into action to catch and grab unsuspecting objects or prey that passes their entryway or exit or to escape.

The fringe 200 is a smart and stylish way to hide the entrance to the box whilst still providing total privacy. The fringe 200 helps avoid anything that can cause box aversion by making it an attractive place for cats. Disguising the entrance or entryway to the box with the fringe and/or housing 100 also may serve as a piece of furniture or other decorative element that can be attractive and placed anywhere in the home or other environment.

In an example, the fringe 200 is provided with individual fibers or strips 240 that are pre-cut and separated from one another. In another example, the fringe 200 includes perforations between adjacent fibers or strips 240 to facilitate separation of fibers or strips 240 by tearing. In another example, the fringe 200 includes a plurality of demarcations indicative of cuts to be made by a user for separating a sheet into individual fibers or strips 240.

Fringe 200 may exhibit a variety of colors and motifs and may be constructed from paper, plastic, or any other suitable material (e.g., at least partially flexible material). In some examples, fringe 200 may also be provided to include strings, beads, small chains and/or other dangling objects, in addition, to or instead of strips or fibers 240. Example fringes may be beautiful, quirky, fun, edgy, stylish, simple, patterned, not patterned or a combination of these. In an example, motifs may be provided corresponding to seasons, sports teams, nationalities, or other (e.g., a logo may be provided at the base of fringed 200).

The example pet toy and shelter 10 may include a covering 410 for wrapping housing 100 or portions thereof. FIG. 6 illustrates a rear view of the example pet toy and shelter 10 after it has been assembled and wrapped with a cover to provide a decorative motif. Covering 410 may be applied inside and/or outside of the housing 100 and may be provided in any of a variety of materials including but not limited to paper or plastic. In an example, the covering 410 may be provided integral to the housing 100 itself (e.g., the housing 100 may be painted or pre-coated with a covering). As with fringe 200, different coverings may be provided in a variety of colors and motifs.

In an example, a lining material may also be provided inside the housing 100, for example, as a coating, A lining may be water-proof or otherwise provide additional durability to the housing 100. As with covering 410, different colors and motifs may be provided by or to a lining.

The example pet toy and shelter 10 may be entirely or partially constructed of materials (e.g., eco-friendly materials) such as cardboard and paper, and may be provided with a finish in any of a variety of colors, patterns, designs or motifs.

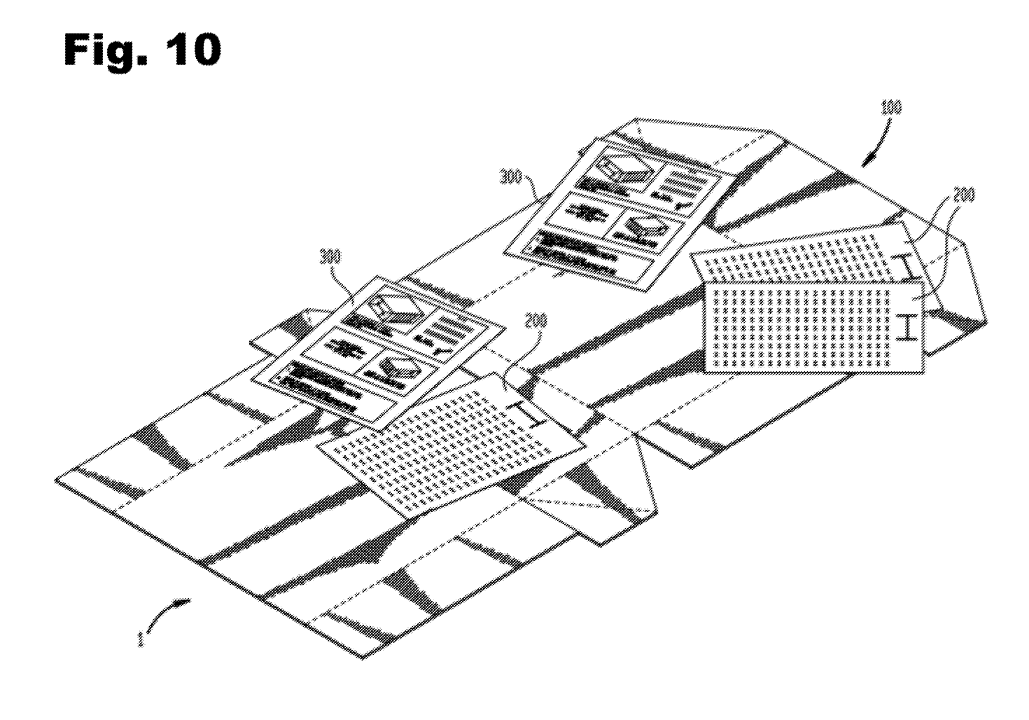

Components of pet toy and shelter 10 such as the housing, fringe and cover may be provided as a kit or system (FIG. 10). In an example, the kit 1 may be provided as a prefabricated fiat pack design packaged together in a thin plastic wrapping, although other packaging is also contemplated, The kit 1 may be provided in a convenient manner for purchase as a complete, grab-and-go package from a retailer or other supplier. The kit 1 may also include instructions for subsequent and easy assembly by purchaser or other end-user.

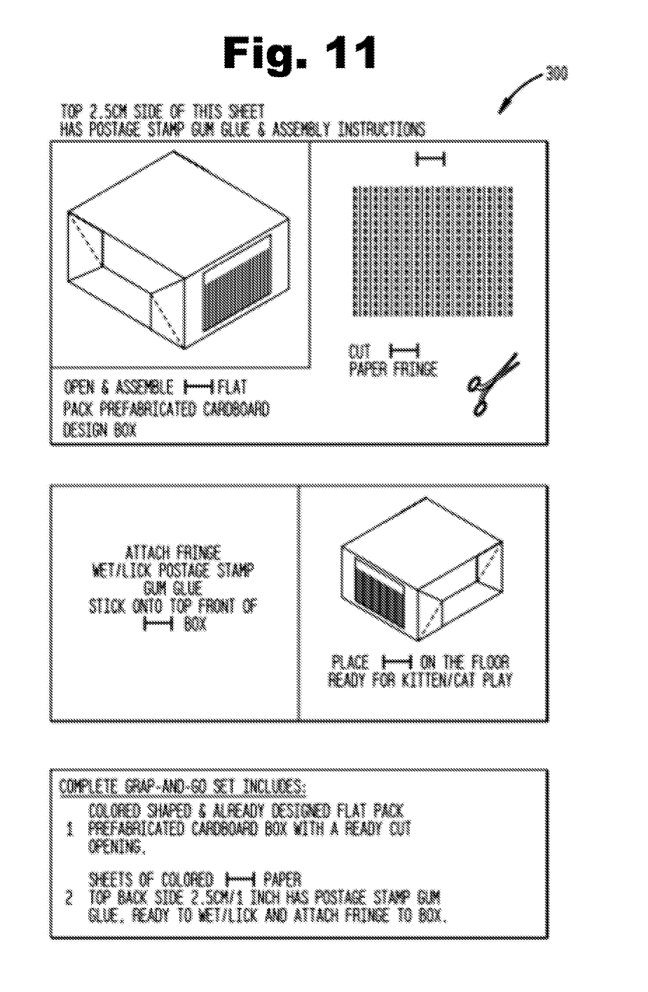

FIG. 11 illustrates example assembly instructions 300 for the pet toy and shelter kit 1. Instructions 300 may describe actions to be taken for opening a package containing the kit 1, assembling the collapsible housing 100, preparing the fringe 200 and coupling the fringe 200 to the collapsible housing 100. It should be noted that instructions 300 are shown only for purposes of illustration, and the instructions are not limited to these example actions.

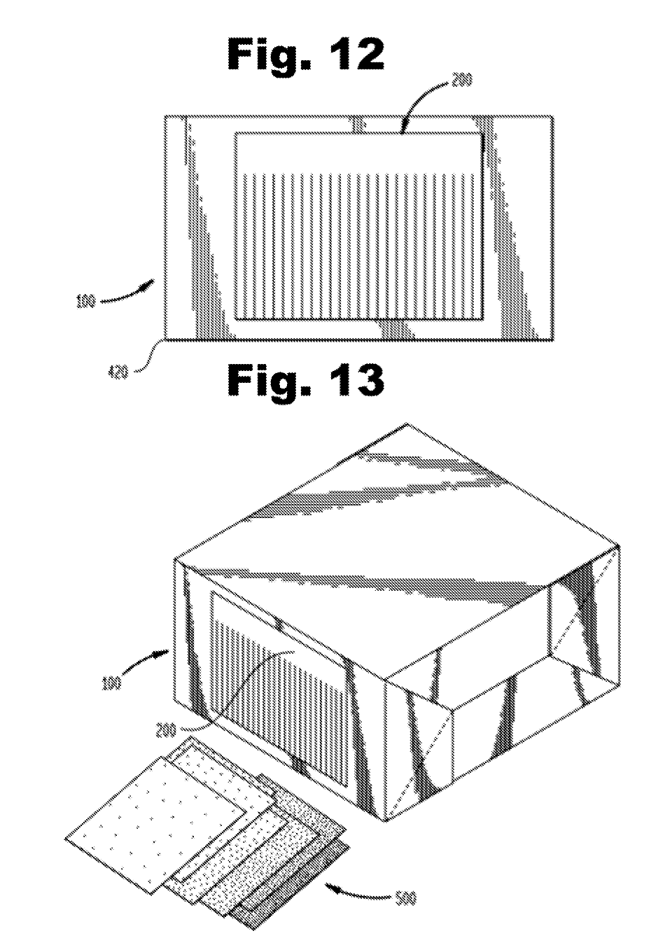

FIG. 12 illustrates an example pet toy and shelter with a decorative frame 420 surrounding passageway 170 and a coupled fringe 200. A variety of different color frames 420 or frame materials may be provided as part of kit 1.

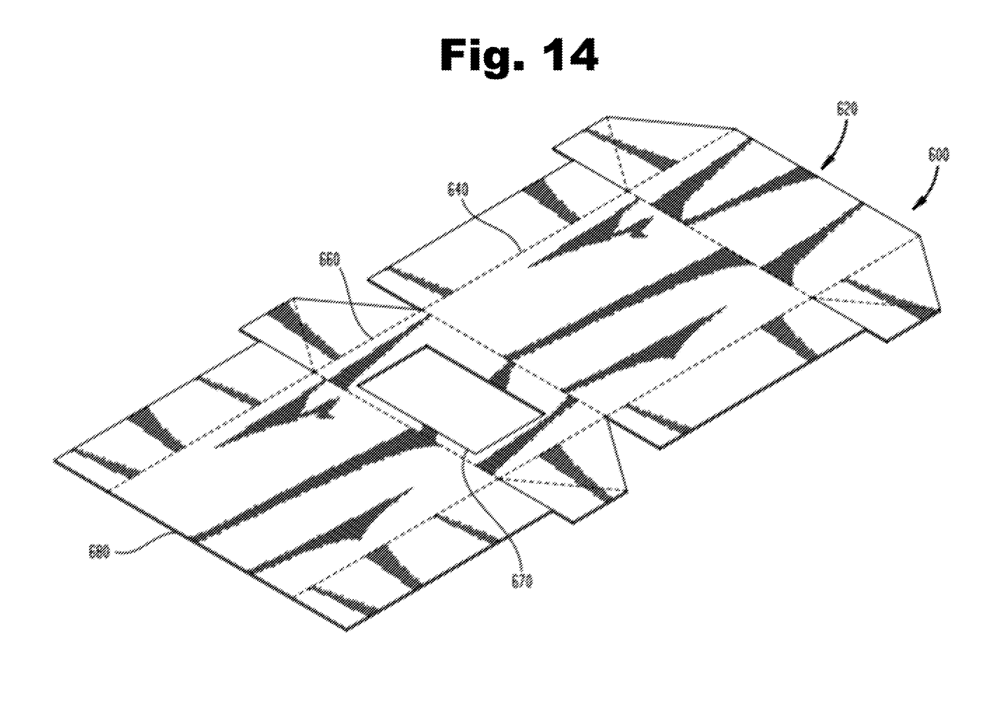

FIG. 13 illustrates an example pet toy and shelter with a fringe and a variety of additional coloring sheets 500 which may be selected and applied by an end user to provide additional beauty to toy and shelter 10 as part of kit 1. In an example, the motif may be readily changed at the user's desire (e.g., for time of year, seasons, or area of use).

Although described herein as the example pet toy and shelter 10 may be constructed cardboard, the example pet toy and shelter 10 is not limited to manufacture of any particular type, color, or shape of material. In addition, the example, the pet toy and shelter 10 may come unassembled in any of a variety of different configurations, and in another example, may come pre-assembled upon purchase. Example pet toy and shelter 10 may be manufactured from plastic or coated with a plastic or similar material so as to be hygienic and may additionally or alternatively be formed of a material or otherwise constructed to be easily disposed of or recycled if worn or otherwise damaged.

Manufacturers may appreciate that the pet toy and shelter 10 may be easily manufactured and efficiently transported for sale locally or globally. In an example, the pet toy and shelter 10 does not even need extra packaging, and so it can be produced at a low cost and on demand as a complete, all-in-one, grab-and-go package or kit.

Before continuing, it should be noted that the examples described above are provided for purposes of illustration, and are not intended to be limiting. Other devices and/or device configurations may be utilized to carry out the operations described herein. Further examples include but are not limited to the pet toy and shelter 10 being incorporated with pet furniture, pet toys, pet accessories, and/or the fringe 200 being used, in front of entry ways or entrances to other devices.

According to an example method of providing pet toy and shelter 10, a sheet or other portion of material is configured with a plurality of relatively pivotable facets 120, 140, 160 and 180 to provide an expandable housing 100. A passage 170 is formed or designated in the housing 100. A fringe 200 is provided for attachment to housing 100 adjacent to and at least partially covering passage 170. The fringe may be produced with a plurality of individual strips, or with designations for individual strips to be separated by the end-user.

In an example pet toy and shelter kit, instructions 300 are supplied to describe actions to be taken for expanding or otherwise erecting housing 100, preparing the fringe 200, and coupling the fringe 200 with housing 100. A variety of fringes 200 may be supplied for at least partially covering the passage 170, and a variety of coverings may also be supplied for at least partially wrapping the outside of housing 100 and/or covering the inside of the house. in an example, one or more closed loops of perforations are formed in one of the plurality of facets 120, 140 160 and 180 to enable an end user to form passage 170 or cut lines are designated on housing 100.

Adjacent facets 120, 140, 160 and 180 are configured with angles there between to expand or erect housing 100. Front facet 160 is folded or otherwise configured into an orientation approximately perpendicular to bottom facet 180; top facet 140 is folded into an orientation approximately perpendicular to front facet 160 and approximately parallel with the bottom facet 180; and back facet 120 is folded into an orientation approximately perpendicular to the top facet 140 and approximately parallel with the front facet 160.

With housing 100 expanded, flaps of the front 160, bottom 180, top 140 and back 120 facets may be overlapped to facilitate selectively maintaining housing 100 in the erected state. First top facet flap 143 and second top facet flap 145 are folded or otherwise configured into orientations approximately perpendicular to top facet 140 in a direction generally towards bottom facet 180 and first front facet flap 165 and second front facet flap 167 are folded into an orientation approximately perpendicular to the front facet 160 in a direction generally towards the back facet 120. With the flaps so configured, sub-flaps may be overlapped therewith to reinforce erected housing 100. A first front facet sub-flap 163 is folded or otherwise configured into an orientation approximately perpendicular to the first front facet flap 165 and a second front facet sub-flap 169 is configured into an orientation approximately perpendicular to the second front facet flap 167. With the sub-flaps folded, sub flap 163 may be glued or interlocked with first bottom facet flap 183 and sub flap 169 may be glued or interlocked with first bottom facet flap 185. Next, first back facet flap 125 and second back facet flap 127 are configured into an orientation approximately perpendicular to the back facet 120 in a direction generally towards the front facet 160. First 183 and second 185 bottom facet flaps are configured into an orientation approximately perpendicular to bottom facet 180 in a direction generally towards to facet 140 where they may be selectively secured to first 125 and second 127 back flaps.

With housing 100 erected and cooperating flaps and sub-flaps permanently or temporarily secured to one another, if a passage has not been formed by a manufacturer or supplier, passage 170 may be formed. In some examples, passage 170 may be formed in housing 100 prior to assembly. Then with the housing 100 erected and passage 170 formed therein, fringe 200 is coupled with front facet 160 adjacent to the passage 170 such that part of the fringe 200 covers passage 170.

As indicated above, coupling fringe 200 may include providing an adhesive such as, glue to fringe base 220 and/or the front facet 160 and adhering the fringe 200 to the front facet 160 or removing a protective strip from adhesive provided to the fringe 200 and adhering the fringe 200 to the front facet 160. In other examples, fringe 200 may be pinned to front facet 160.

Prior to coupling fringe 200 to housing 100, adjacent strips/fibers 240 may be separated. Separation of adjacent strips or fibers 240 may include cutting along a plurality of demarcations provided between adjacent strips/fibers 240 or may include tearing along a plurality of perforations provided between adjacent strips/fibers 240.

Operations to assemble and use the pet toy and shelter 10 shown and described herein are provided to illustrate example implementations. It is noted that the operations are not limited to the ordering shown. Still other operations may also be implemented. For example, front facet 160 may be configured into a perpendicular orientation relative to top facet 140 prior to configuring front facet 160 into a perpendicular orientation relative to bottom facet 180.

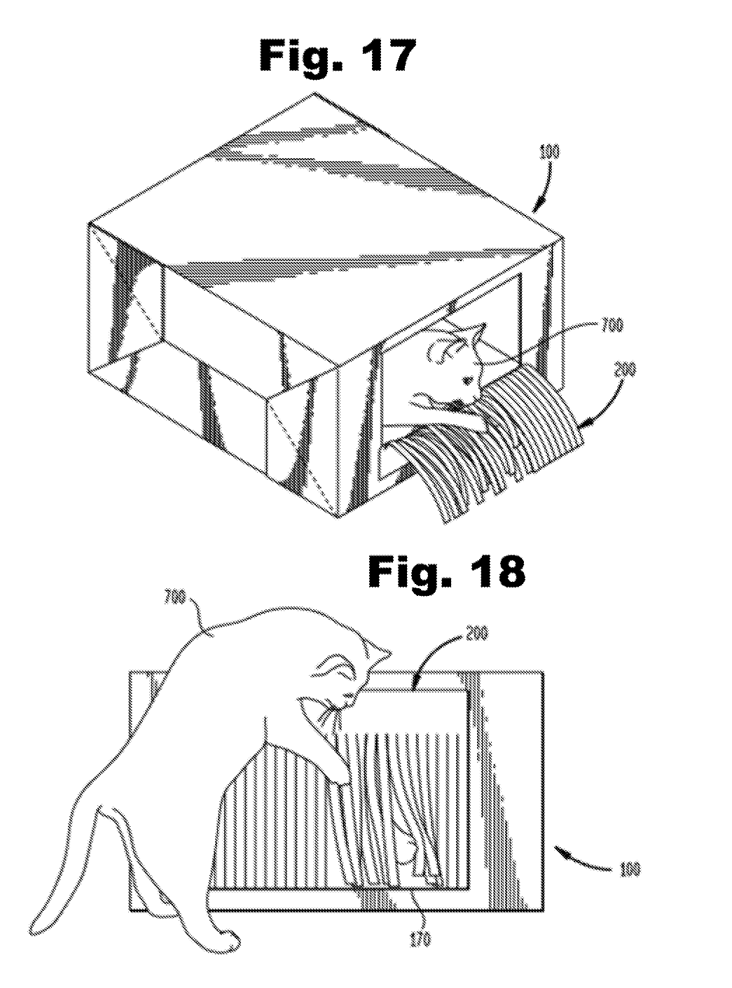

The pet toy and shelter 10 may be utilized as a toy, a play and exercise apparatus, and a personal territory and secure shelter, e.g., for pets to sleep or rest in, or it may be used as an entryway or entrance way to a housed or hooded box and/or as an enclosed box housing. Pets that use the pet toy and shelter 10 may live longer, healthier active lives. For example, the pet toy and shelter 10 may help keep pets mentally and physically sharp and may compliment other pet toys or products. FIGS. 15-18 illustrate a pet 700 engaging with the example pet toy and shelter 10. Of course, use of the example pet toy and shelter 10 is not limited to these illustrations.

It is noted that the base 220 of fringe 200 is shown above strips 240. However, other orientations may also be enjoyed by pets. For example, a pet 700 may be stimulated by the arrangement of base 220 below strips 240 (FIG. 18). This may be accomplished either by resting toy and shelter 10 on top facet 140 rather than bottom facet 120 or by coupling fringe 200 to front facet 160 in an inverted orientation at a location adjacent to bottom surface 180.

While housing 100 has generally been referred to as collapsible, it should be noted that housing 100 is collapsible from an expanded state but expandable from a collapsed state. As such, housing 100 may be described either as collapsible or expandable depending on the reference state. In other examples, the housing 100 may be provided in a non-collapsible state (e.g., as a hard shell).

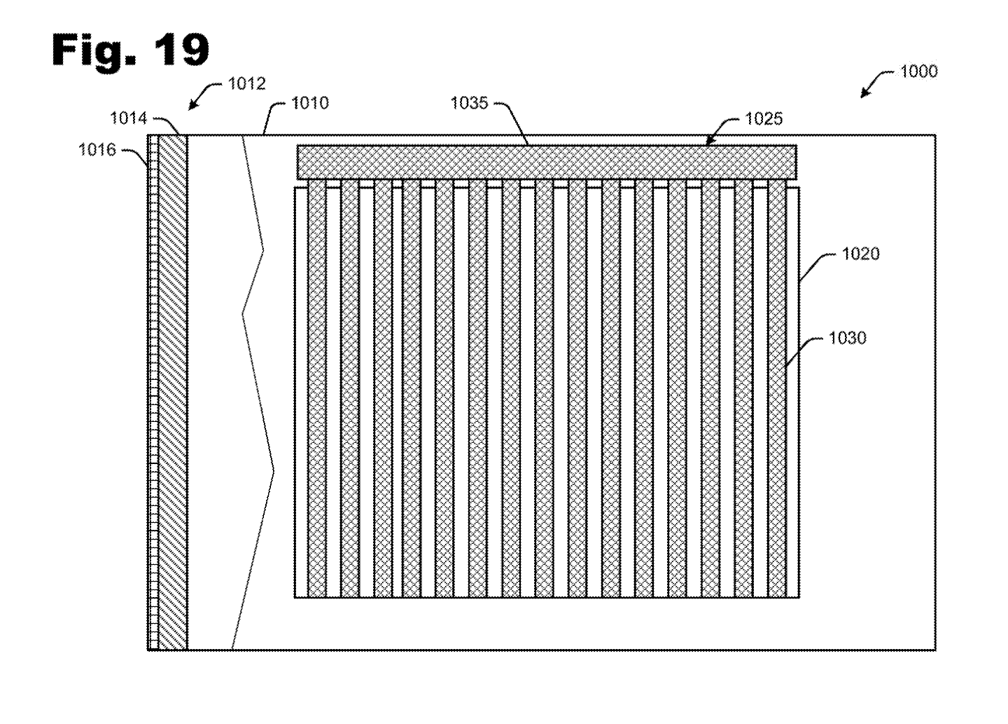

Still other embodiments of the pet toy and shelter are contemplated. Illustrative examples are shown and described now with reference to FIGS. 19-25.

FIG. 19 is a front view showing an example pet toy and shelter 1000. The example pet to and shelter 1000 includes a collapsible housing 1010. In an example, the collapsible housing 1010 is configured to be oriented, both upright and upside down (see, e.g., FIGS. 17 and 18) so that the fringe curtain 1025 provides cover, a hiding place, a curtain from which to look out or through, shelter for the pet to relax and sleep in, and entertainment for the pet.

In an example, the collapsible housing 1010 has a support structure 1012. In this example, the support structure 1012 has multiple layers 1014 and 1016, although any number of layers may be provided. By way of example, layer 1014 is an inner structural layer (e.g., corrugated cardboard) and layer 1016 is an outer decorative layer. The layers may be laminated. Other layers may also be included, such as but not limited to an outer dear layer (e.g., a laminating plastic), a middle structural layer, and an inner insulating layer. Still other examples of layers are contemplated, as will be readily appreciated by those having ordinary skill in the art after becoming familiar with the teachings herein.

The pet toy and shelter 1000 also includes at least one passage 1020 formed therein for entry and exit of a pet. It is noted that multiple passages may be included. For example, a passage may be included on two or more sides of the pet toy and shelter 1000 (e.g., a front and rear entry). Or for example, multiple passages may be included on one or on each side of the pet toy and shelter 1000 (e.g., multiple entries on one side, or multiple entries on multiple sides). Likewise, the pet toy and shelter 1000 may include one or more dividers or “rooms” with internal passages. A fringe curtain 1025 may be provided on some or all of the different passages.

A fringe curtain 1025 may be provided to at least partially cover the passage 1020 in the collapsible housing of the pet toy and shelter 1000. In an example, the fringe curtain 1025 has a plurality of strips 1030. A valence 1035 may also be provided.

It is noted that the fringe curtain 1025 may be made of any suitable material. Examples include, but are not limited to, laminated plastic, absorbent material, and fiberboard. It is also noted that the fringe curtain may be positioned inside or outside of the collapsible housing adjacent the passage. In addition, the fringe, curtain 1025 can be permanently or removably attached adjacent the passage 1020. For example, the fringe curtain 1025 can be removably attached with hook-and-loop fasteners (e.g., VELCRO™), brackets, rods, poles, and pre-gummed adhesive.

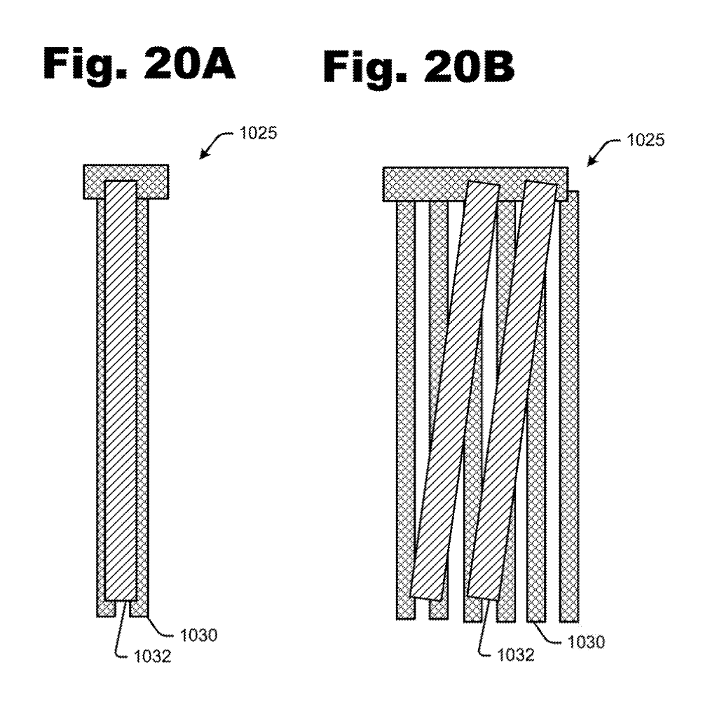

The fringe curtain 1025 of the pet toy and shelter 1000 may have any of a variety of different configurations, as illustrated by way of example in FIGS. 20A through 24.

In FIGS. 20A-20B, the fringe curtain 1025 is shown having a plurality of layers. Only a portion of the fringe curtain 1025 is shown to simplify the drawing. For example, the fringe curtain 1025 includes a first layer including strips 1030 and a second layer including strips 1032. The second layer overlaps the first layer. In FIG, 20B the strips 1032 are shown at an angle (e.g., diagonal) relative to the strips 1030.

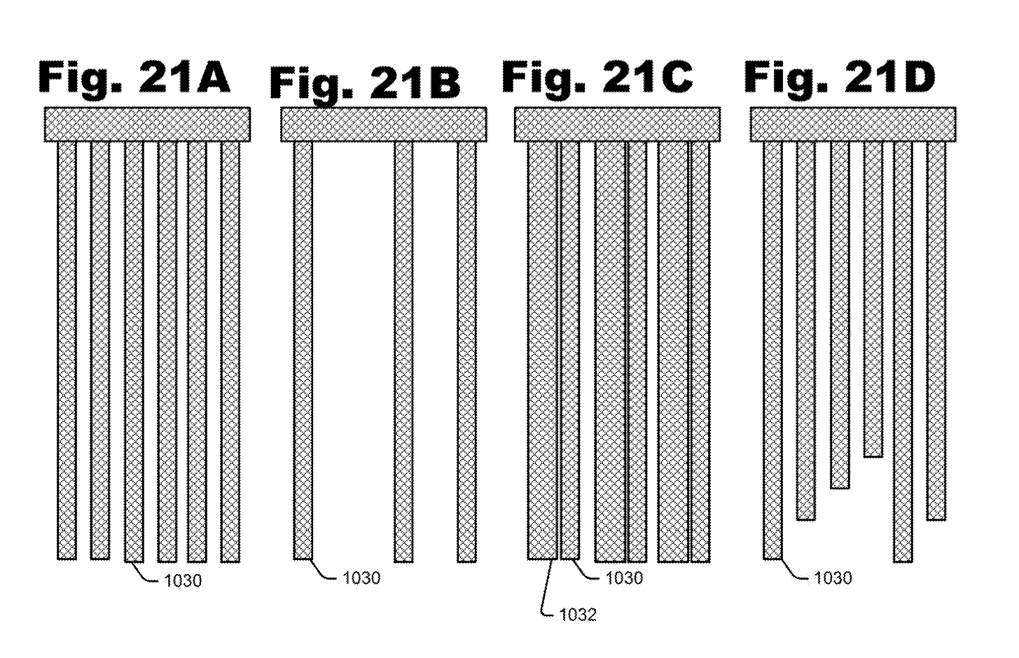

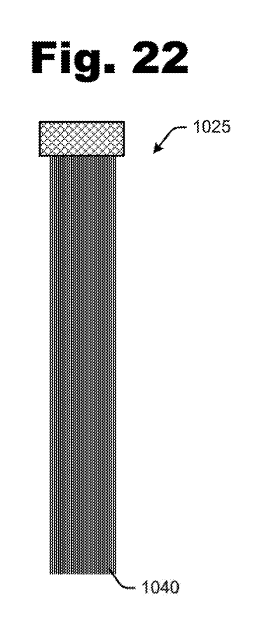

In FIGS. 21A-21D, the fringe curtain 1025 is shown having a variety of spacing between the strips 1030. In FIG. 21A, the strips 1030 are evenly spaced across the passage. In FIG. 21B, the strips 1030 are unevenly spaced across the passage. Other illustrative examples are shown in FIGS. 21C and 21D. In FIG. 21C, the strips 1030 and 1032 have different thicknesses. It is noted that the strips may be varying thickness in both dimensions. Likewise, the strips may be of uniform or varying weight. In FIG. 21D, the fringe curtain includes different length strips. Yet another example is shown in FIG. 22, wherein the fringe curtain 1025 is formed as a brush 1040. Still other examples are contemplated, as will be readily appreciated by those having ordinary skill in the art after becoming familiar with the teachings herein.

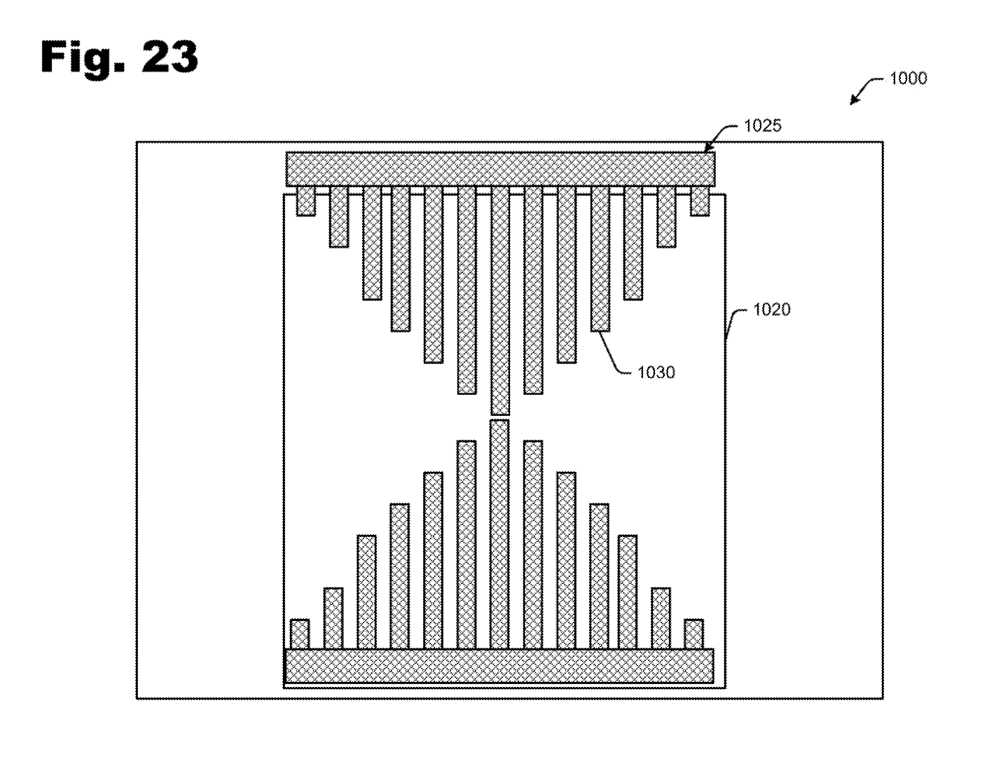

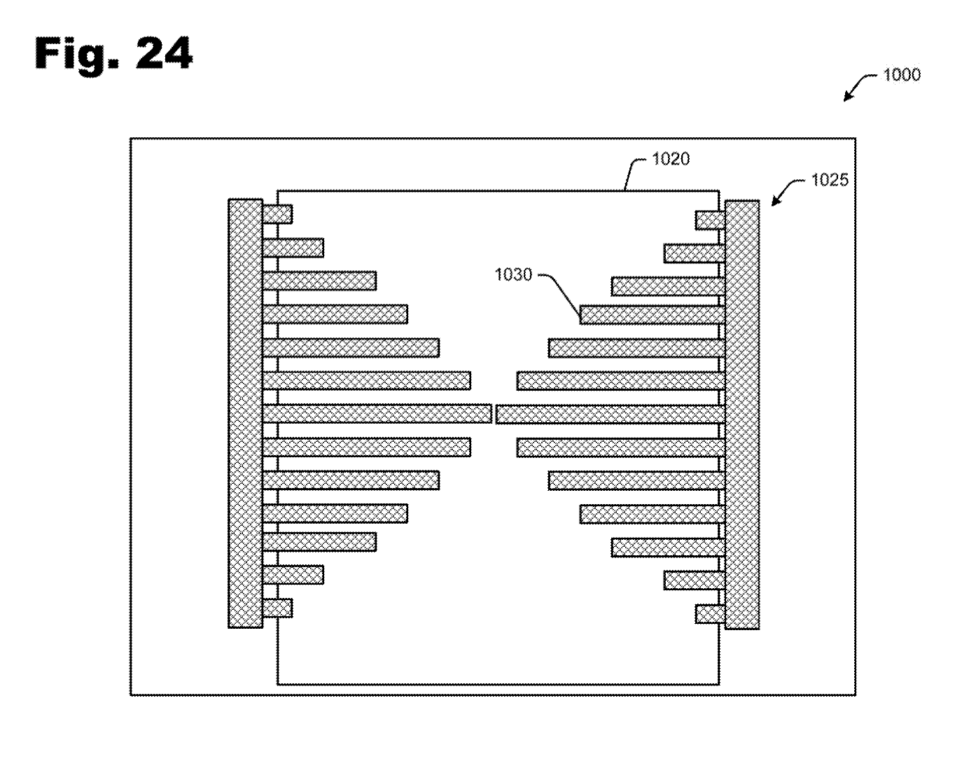

In FIGS. 23 and 24, the fringe curtain 1025 is shown as it may include at least one semi-rigid strip 1030. In an example, the at least one semi-rigid strip stands as a column over at least a portion of the at least one passage, as shown in FIG. 23. In another example, the at least one semi-rigid strip extends in a horizontal orientation across at least a portion of the at least one passage, as shown in FIG. 24. The configurations of FIGS. 23 and 24 are shown only for purposes of illustration. Still other configurations are contemplated, such as but not limited to a combination of rows and columns.

It should be noted that the fringe curtain 1025, although shown stationary, may also be moveable about at least a portion of the passage 1020. For example, the fringe curtain 1025 may slide back and forth across the passage 1020 similar to a window curtain. Movement may be manual or controlled by a drive motor.

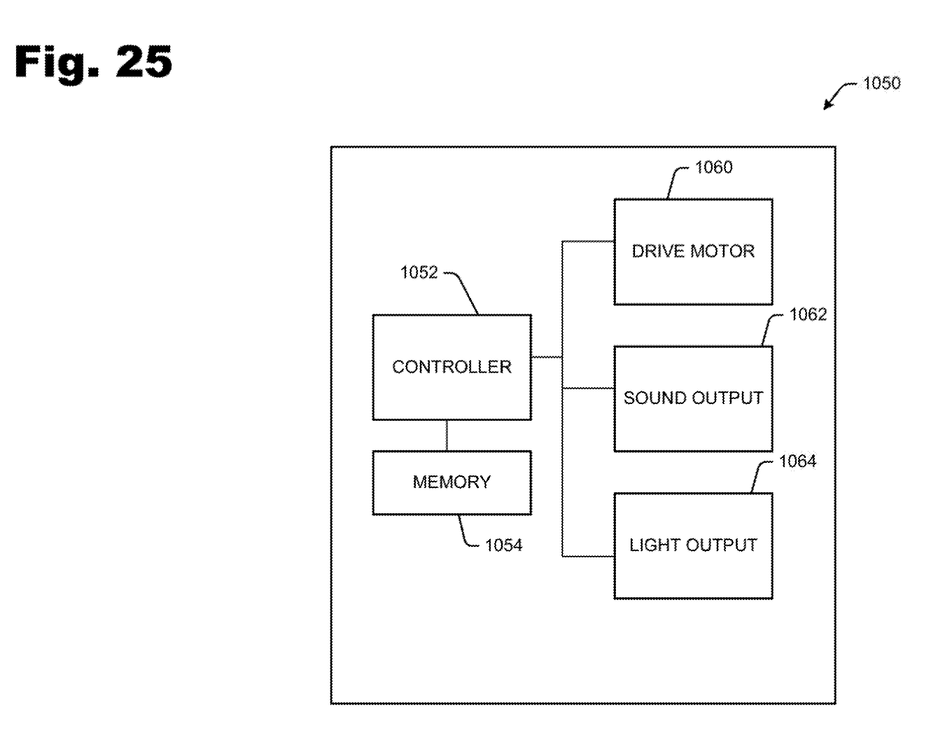

FIG. 25 is a high-level block diagram of a control system 1050 for the pet toy and shelter. The control system 1050 may include control electronics such as, but not limited to a printed circuit board with a controller 1052 and memory 1054 operable to control a drive motor 1060, sound output 1062 (e.g., speakers), and/or light output 1064 (e.g., lighting). The control electronics may also be configured to control other devices not specifically mentioned, but commercially available now or in the future. The control electronics (e.g., controller, drive motor, sound and/or light output) may be provided in any suitable location, internal or external, to the pet toy and shelter.

In an example, the drive motor 1060 may automatically move the fringe curtain 1025 to different positions. The output device 1062 may be configured to output sound (e.g., the chirp of a bird). The output device 1064 may be configured to output light. Output by any of the devices (e.g., 1060, 1062, and/or 1064) may be in response to movement of the fringe curtain 1025, e.g., based on sensor input. Light and/or sound may include any of a variety of different types of light and/or sound, position of the light and/or sound, etc.

It is noted that the examples shown and described are provided for purposes of illustration and are not intended to be limiting. Still other examples are also contemplated.

1. A pet toy and shelter, comprising:
a collapsible housing having a support structure, and at least one passage formed therein for entry and exit of a pet; and
a fringe curtain to at least partially cover the passage in the collapsible housing, the fringe curtain having a plurality of strips;
wherein the collapsible housing is configured to be oriented both upright and upside down so that the fringe curtain provides cover, a hiding place, a curtain from which to look out or through, shelter for the pet to relax and sleep in, and entertainment for the pet.

2. The pet toy and shelter of claim 1, wherein the fringe curtain includes a plurality of layers.

3. The pet toy and shelter of claim 2, wherein one of the plurality of layers overlaps another of the plurality of layers.

4. The pet toy and shelter of claim 3, wherein the plurality of layers are angled relative to one another.

5. The pet toy and shelter of claim 1, further comprising a plurality of spaces between each of the strips, wherein the strips are evenly spaced across the passage.

6. The pet toy and shelter of claim 1, further comprising a plurality of spaces between each of the strips, wherein the strips are unevenly spaced across the passage.

7. The pet toy and shelter of claim 1, wherein each strip is spaced apart from an adjacent strip.

8. The pet toy and shelter of claim 1, wherein the strips are fibers which form brush.

9. The pet toy and shelter of claim 1, wherein the fringe curtain includes laminated plastic.

10. The pet toy and shelter of claim 1, wherein the fringe curtain includes absorbent material.

11. The pet toy and shelter of claim 1, wherein the fringe curtain includes fiberboard.

12. The pet toy and shelter of claim 1, wherein the fringe curtain includes different thickness strips.

13. The pet toy and shelter of claim 1, wherein the fringe curtain includes different length strips.

14. The pet toy and shelter of claim 1, wherein the fringe curtain includes different weight strips.

15. The pet toy and shelter of claim 1, wherein the fringe curtain is moveable about at least a portion of the passage.

16. The pat toy and shelter of claim 15, further comprising a drive motor to automatically move the fringe curtain to different positions.

17. The pet toy and shelter of claim 1, wherein the fringe cu in includes at least one semi-rigid strip.

18. The pet toy and shelter of claim 17, wherein the at least one semi-rigid strip extends in a horizontal orientation across at least a portion of the at least one passage.

19. The pet toy and shelter of claim 17, wherein the at least one semi-rigid strip stands as a column or a row over at least a portion of the at least one passage.

20. The pet toy and shelter of claim 1, further comprising at least one valence.

21. The pet toy and shelter of claim 1, further comprising an output device configured to output sound in response to movement of the fringe curtain.

22. The pet toy and shelter of claim 1, further comprising an output device configured to output light in response to movement of the fringe curtain.

23. The pet toy and shelter of claim 1, wherein the fringe curtain is positioned inside the collapsible housing adjacent the passage.

24. The pet toy and shelter of claim 1, wherein the fringe curtain is removably attached adjacent the passage.
